(19) United States
(12) Patent Application Publication
(10) Pub. No.: US 2008/0317970 A1
(43) Pub. Date: Dec. 25, 2008

(54) Method for producing an electrical connection using individually sheathed nanotubes

(75) Inventors: Jean-Christophe Coiffic, Grenoble (FR); Jean Dijon, Champagnier (FR)

Correspondence Address: OLIFF & BERRIDGE, PLC, P.O. BOX 320850, ALEXANDRIA, VA, 22320-4850, US

(73) Assignee: COMMISSARIAT A L'ENERGIE ATOMIQUE, Paris (FR)

(21) Appl. No.: 12/213,276

(22) Filed: Jun. 17, 2008

(30) Foreign Application Priority Data
Jun. 22, 2007 (FR) 07 04463

(51) Int. Cl. B29C 71/04

(52) U.S. Cl. 427/532

(57) ABSTRACT

An electrical connection comprising nanotubes is made between two layers of metallic material separated by a layer of insulating material. After growing the nanotubes, their alignment substantially perpendicularly to the metallic levels is performed by means of an electromagnetic alignment field. Then a sheathing material is deposited, at least partially covering the nanotubes and performing at least individual sheathing of the nanotubes. The electromagnetic alignment field of the nanotubes is maintained during deposition of the sheathing material.

### BACKGROUND OF THE INVENTION

The invention relates to a method for producing an electrical connection, comprising nanotubes, between two layers of metallic material separated by a layer of insulating material, the nanotubes being at least partially covered by at least one metallic material.

### STATE OF THE ART

Carbon nanotubes are currently the subject of large research efforts as their monoatomic cylindrical structure gives them exceptional properties on the nanometric scale. A promising application consists in using nanotubes in interconnects, in particular in the microelectronics industry, as described by Nihei et al. (“Electrical Properties of Carbon Nanotube Bundles for Future Via Interconnects” Japanese Journal of Applied Physics Vol. 44 N°4A, 2005 pp 1626-1628). These interconnects are formed by two conducting metal lines, currently made of copper, situated above one another thus forming two metallic levels connected by conducting bridges called vias.

To withstand the stresses imposed by the reduction of size added to complexification of the integration parameters, it is envisaged to use carbon nanotubes as nanometric metal wires for the interconnects. The latter do in fact possess very interesting intrinsic properties compared with copper.

One of the difficulties involved in the use of carbon nanotubes in interconnects lies in particular in how to achieve the contacts with a metallic material at each end of the nanotube. As growth of the nanotubes takes place upwards, the bottom contact is made naturally when the nanotubes are produced. The contact of the upper part poses more problems. This does in fact involve correctly connecting the metallic level of the top contact while at the same time optimizing the contact surface with respect to the total length of the nanotubes.

Moreover, contact connection is all the more difficult as the nanotubes used for these interconnects may be locally curved and intertwined.

U.S. Pat. No. 7,135,773 describes a method for producing an interconnect comprising carbon nanotubes connecting two metallic levels made from copper. Once the nanotubes have been produced in the via, the latter is filled with the copper which performs mechanical securing of the nanotubes. However in practice, the structure described in this patent cannot really be achieved with carbon nanotubes but only with carbon nanofibers, which are more rigid. Correct filling of the via is in fact only possible if the nanotubes, obtained by catalytic growth, are aligned vertically and above all individually.

U.S. Pat. No. 6,837,928 describes the use of an electrical field during growth or subsequent to growth of nanotubes to achieve alignment of the latter according to the electrical field. The electrical field described is typically about 1 V/μm.

The document WO-A-03/087707 describes metallization of carbon nanotubes to be able to align the carbon nanotubes by means of a magnetic field acting on the metal.

US Patent application 2005/0208304 describes at least partial coating of nanotubes by a metal.

### OBJECT OF THE INVENTION

The object of the invention consists in achieving a nanotube-based interconnect structure that is easy to implement and that ensures good contact performance between the metallic levels and the nanotubes.

The method according to the invention is characterized in that it comprises alignment of the nanotubes substantially perpendicularly to the metallic levels by means of an electromagnetic alignment field, between growth of the nanotubes and deposition of said metallic material, followed by deposition of a sheathing material covering the nanotubes at least partially and performing at least individual sheathing of the nanotubes, the electromagnetic alignment field of the nanotubes being maintained during deposition of the sheathing material.

### BRIEF DESCRIPTION OF THE DRAWINGS

Other advantages and features will become more clearly apparent from the following description of particular embodiments of the invention given as non-restrictive examples only and represented in the accompanying drawings, in which:

FIGS. 1 to 5 represent the main steps of production of an interconnect structure according to the invention in schematic manner in cross-section,

FIGS. 6 and 7 represent a cross-section of an alternative embodiment of an interconnect structure according to the invention, in schematic manner.

### DESCRIPTION OF PREFERRED EMBODIMENTS OF THE INVENTION

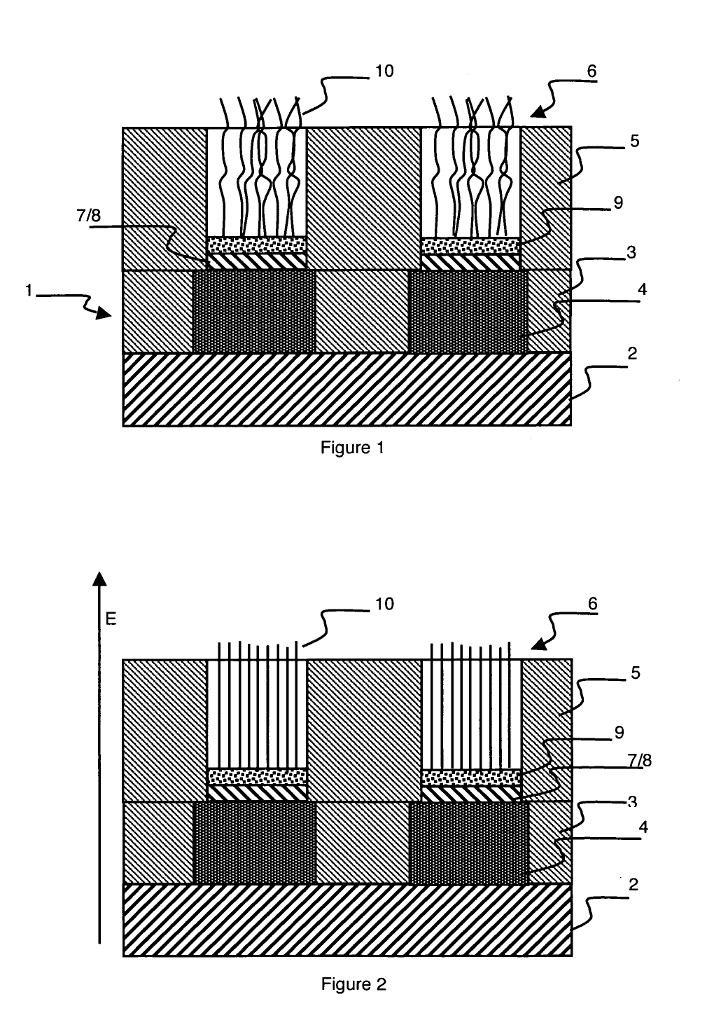

As illustrated in FIG. 1, a first metallic level 1 is produced on a support 2. Support 2 is for example formed by a silicon substrate and can comprise a plurality of layers. First metallic level 1 is achieved in conventional manner and comprises an alternation between a first insulating material 3 and a first metallic material 4. First metallic material 4 thus forms patterns in first insulating material 3, over the whole height thereof. First metallic material 4 is for example made of Cu, Al, W, Ag, Pt, Pd, Ti, TiN, Ta, TaN, Mo or one of their alloys. First insulating material 3 is preferably made from a low-k material, for example silicon oxide. The thicknesses of layers 3 and 4 are typically those used in a conventional metallic interconnect structure.

A layer 5 of insulating material is then deposited on first metallic level 1. This insulating material layer 5 is then patterned by any suitable technique, for example by photolithography and etching, so as to form at least one via 6 and thereby leave access to certain patterns in first metallic material 4. In a first embodiment, patterning of insulating material layer 5 enables creation of holes or vias 6 in the form of recesses having substantially vertical side walls that are straight over the whole height of insulating material layer 5.

After patterning of insulating material layer 5, the bottom of vias 6 is then materialized by zones of first metallic material 4 of first metallic level 1. The shape of vias 6 is conventionally square or round, but may also present various shapes.

As illustrated in FIG. 1, an adhesion layer 7 and/or a barrier layer 8 is then advantageously deposited on the whole of the structure. Adhesion layer 7 strengthens the adhesion of barrier layer 8 on layer 4. Adhesion layer 7 is for example made of Ta, TaN, TiN, Ti, Al, Ru, Mn, Mo, Cr, and its thickness is advantageously less than 10 nm and may go down to deposition of an atomic layer. Barrier layer 8, generally used to prevent interdiffusion of a catalyst 9 with first metallic material 4, is for example made of Al, Al₂O₃, TiN, Ti, Ta, TaN, Mn, Ru, or Mo. Barrier layer 8 can also be self-positioned by electroless chemical deposition, i.e. it only deposits on the zones made of first metallic material 4. Barrier layer 8 is then for example made of CoWP, CoWB, CoWP/B, NiMoP, NiMoB or any metal and alloys thereof. Barrier layer 8 can also be formed by a multilayer. Adhesion layer 7 and barrier layer 8 are deposited by any suitable technique, for example by evaporation, or sputtering under a neutral gas plasma, for example argon, helium or hydrogen. Advantageously, if first metallic material 4 is made of copper, a Tantalum (Ta) adhesion layer 7 and a barrier layer 8 able to be made of TaN, TiN or Ru will be used.

A layer of catalyst 9 designed to enable growth of nanotubes 10 is then formed in the bottom of vias 6. Catalyst 9 is for example Co, Ni, Fe, Al, Al₂O₃, Mo. Catalyst 9 is deposited by any suitable technique. This layer is for example deposited on the bottom of vias 6 and on the top faces of layer 5 by directional deposition, with addition of material perpendicularly to substrate 2. The catalyst can also be self-positioned and is then made for example from CoWP, CoWP/B, NiMoB, their oxides or their alloys. In certain cases, catalyst 9 and barrier layer 8 are one and the same and are for example made of CoWP, CoWP/B, NiMoB. Catalyst 9 can also be deposited in the form of clusters or in the form of a multilayer of different materials.

In the case where catalyst 9, adhesion layer 7 and/or barrier layer 8 are deposited on insulating material layer 5 around vias 6, these layers are eliminated at these locations. Removal of these materials is performed by any known means and in particular by etching or chemical mechanical polishing on insulating material layer 5. Catalyst 9 and barrier layer 8 and/or adhesion layer 7 in this way only finally remain present at the bottom of vias 6.

Growth of nanotubes 10, preferably made from carbon, is then performed. Growth of nanotubes 10 is performed in conventional manner from catalyst 9 deposited on first metallic material 4 at the bottom of vias 6. Growth of nanotubes 10 can be achieved by any suitable technique, for example by chemical vapor deposition (CVD), plasma enhanced chemical vapor deposition (PECVD), Electron Cyclotron Resonance (ECR), chemical vapor deposition with hot filament, laser enhanced chemical vapor deposition, etc. Preferably, a technique enabling growth of carbon nanotubes 10 from a catalyst and at a temperature of less than 900° C. is used. The gases used in formation of carbon nanotubes can be CO, C₂H₂, CH₄, Fe(C₅H₅)₂, xylene, metallocenes, alcohols in gaseous state and all carbonaceous gases, H₂, NH₃, H₂O, O₂ or a mixture of these gases. Carbon may also be added by means of a graphite sole etched by a plasma.

Growth of nanotubes 10 takes place from the bottom of vias 6, i.e. from catalyst 9, until the height of the opening of via 6 in layer 5 is exceeded.

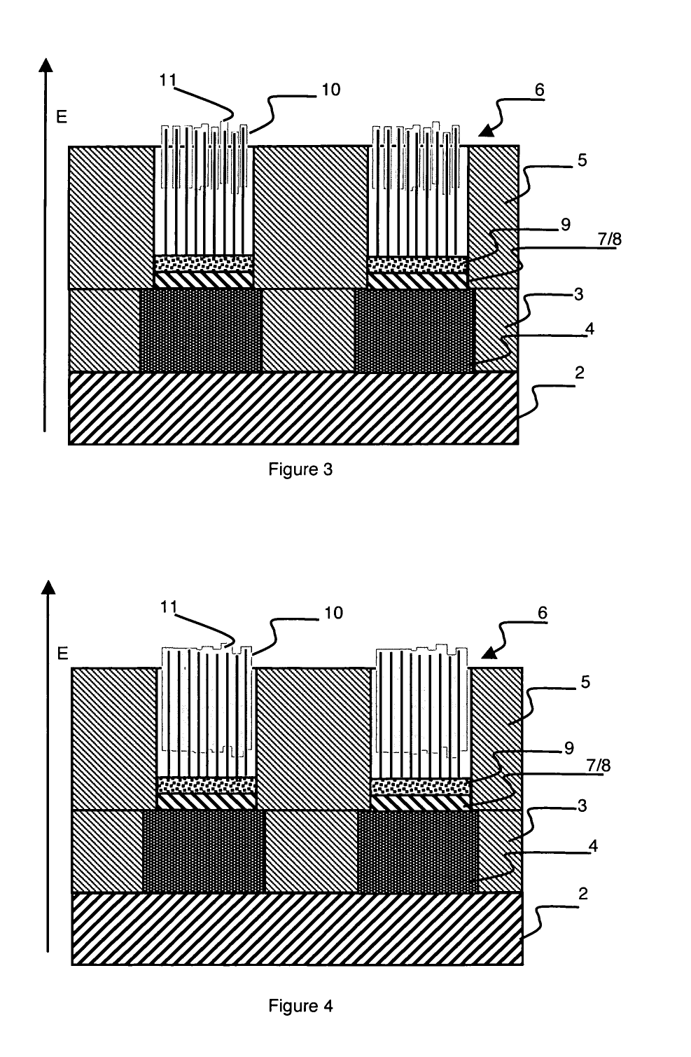

To obtain nanotubes 10 presenting the same orientation (FIG. 2), an electromagnetic alignment field is applied after growth of nanotubes 10. The characteristics of the electromagnetic field are chosen so that the nanotubes are then deployed and oriented substantially perpendicular to first metallic 1 level and parallel to the side walls of orifices 6.

Only one of the electrical or magnetic components of the electromagnetic field can be used to perform alignment of nanotubes 10. In the case where an electrical field is applied to nanotubes 10 to orient the latter, the electrical component (E) is preferably lower than the disruptive threshold value of the gas present in the deposition chamber. Advantageously, an electrical field of less than 100V/μm and even more advantageously a field of about 1V/μm is applied at the level of the nanotubes. This electrical field is for example applied by means of electrodes arranged on each side of the stack formed by the substrate/metallic level/insulating material layer. Advantageously, the target containing the material to be deposited is situated on the side of the electrode where the polarization voltage is applied.

Advantageously, a permanent magnet system can be used to force the free electrons of the plasma to enter into collision with the atoms composing the plasma gas.

In this way, at least the top part of each of nanotubes 10 is deployed individually and aligned according to the electrical field. The geometric defects of nanotubes 10 are thereby lessened by straight shaping of the nanotubes.

Nanotubes 10 are then kept straight and parallel by means of the electromagnetic alignment field while a sheathing material 11 is deposited. Sheathing material 11 is deposited conformally, i.e. it follows the shape of the surface on which it is deposited perfectly. Sheathing material 11 is for example made of conducting material, for example carbon or a metal chosen from Pd, Au, Ti, TiN, Al, Ta, TaN, Cr, Cu, Ag, Pt, Mo, Co, Ni, Fe, and all their alloys. However, sheathing material 11 can also be made from insulating material, for example from Al₂O₃, MgO, SiO₂, SixNx, SiOC, TiO₂. Sheathing material 11 can be of hydrophobic or hydrophilic nature, it can also be biocompatible and be deposited in the form of one or more layers.

Advantageously, the deposition conditions are chosen such that deposition of sheathing material 11 remains of conformal type as far as possible inside the via. As a conformal-type deposition is made on each nanotube 10, the length and surface contact between sheathing material 11 and each nanotube are considerably increased. Thus, if sheathing material 11 is conducting, the quality of contact between nanotube 10 and sheathing material is improved and tends towards a contact of ohmic type.

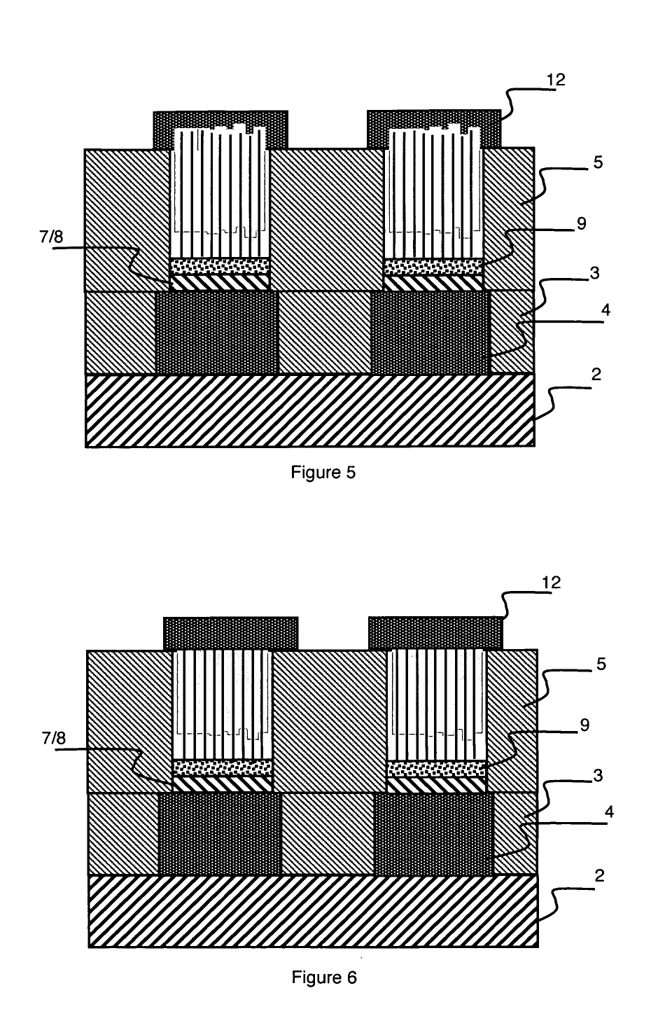

The deposition thickness of sheathing material 11 is adjusted according to the specific features sought for. If, as illustrated in FIG. 3, deposition having a maximum contact length without coalescence of the nanotubes is sought for, then a thin deposition, for example less than 70 nm, is made. If a subsequent polishing step is scheduled, the thickness of the deposition is increased to form a solid shell incorporating at least the top part of all the nanotubes (FIG. 4).

After deposition of sheathing material 11 which advantageously has a contact length of more than 1 μm, the orientation of nanotubes 10 is final, i.e. even in the absence of an electromagnetic field. As sheathing material 11 acts as a sheath around each nanotube 10, the electromagnetic field is then in fact eliminated.

Advantageously, an additional annealing step is used to make sheathing material 11 diffuse and/or to form an alloy with carbon nanotube 10. For example, if sheathing material 11 is made of titanium, a TiC alloy is formed.

As illustrated in FIG. 5, deposition of a second metallic material 12 is then performed, and is then patterned, in conventional manner. Second metallic material 12 is for example made from Cu, Au, Al, W, Ag, Pt, Pd, Ti, TiN, Ta, TaN, Mo or one of their alloys, and its thickness is preferably comprised between 5 nm and 100 μm. Layers of first metallic material 4 and second metallic material 12 are thus electrically connected by means of nanotubes 10. In this embodiment, connection of the two metallic materials 4, 12 is essentially performed by the external walls of nanotubes 10.

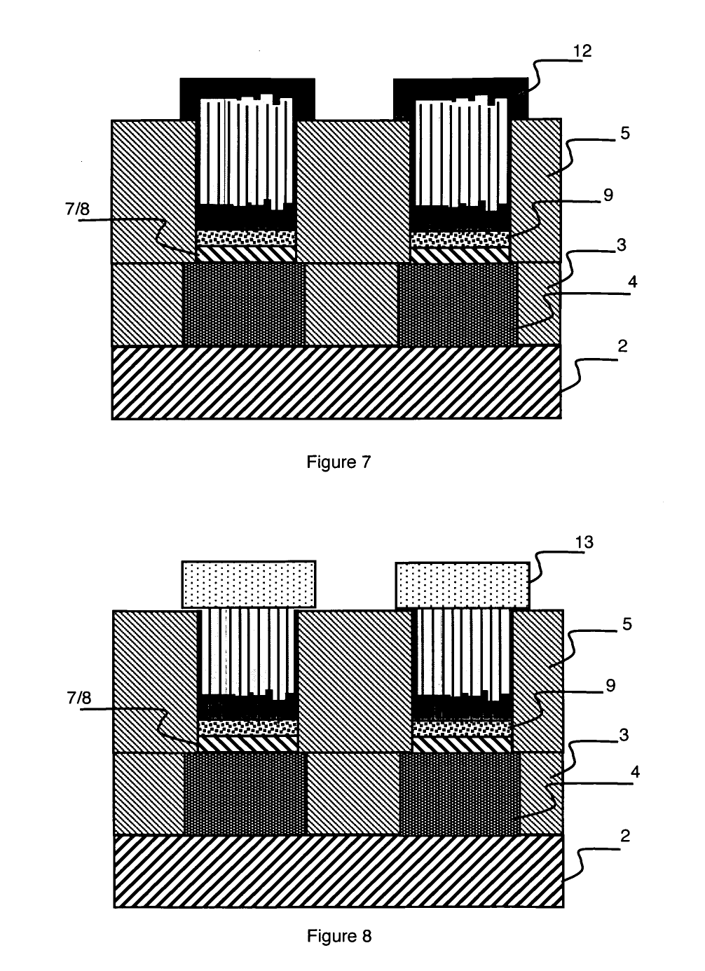

In an alternative embodiment illustrated in FIG. 6, an additional polishing step is performed. This chemical mechanical polishing step is advantageously used to trim the top ends of nanotubes 10 before deposition of metallic material layer 12 and to thereby allow material 12 to access the internal walls of the nanotubes.

In another alternative embodiment illustrated in FIG. 7, to obtain electrical connections that are as conducting as possible, vias 6 are filled with a metallic material. Once sheathing material 11 has been disposed on the bulk of the length of nanotubes 10, electrochemical deposition (electroless deposition) is perform to at least partially fill via 6. To facilitate electrochemical deposition, the sheathing material is chosen as conducting as possible. In this way, the electrochemically deposited material fills via 6 and can also form the layer of second metallic material 12 above layer 5. The material deposited by electrochemical deposition is preferably copper. It can also for example be made of Al, Au, Pd, Ag, Ni, Fe, Cr, Ti, Pt, C, Co, Mo, Ru, or an alloy of the latter. The material deposited by electrochemical deposition can also be a charge transfer compound, like Bechgaard's salts, such as tetra-methyl tetra selenafulvalene-based (TMTSF) salts or bisethyidithio-tetrathiafulvalene (BEDT-TTF) salts or again tetra-methyl tetrathiafulvalene (TMTTF) salts. Advantageously, when the deposition completely fills the voids between the nanotubes, it enables the conductivity of the interconnect structure to be increased. Furthermore the interconnect is mechanically strengthened to perform for example a chemical mechanical polishing step.

If polishing is used for example to have access to the internal walls of nanotubes 10, deposition of a third metallic material 13 is then performed and patterned to achieve a second metallic level (FIG. 8). Third metallic material 13 is for example made from Cu, Al, W, Ag, Pt, Pd, Ti, TiN, Ta, TaN, Mo or an alloy of the latter.

1. A method for producing an electrical connection, comprising nanotubes, between two layers of metallic material separated by a layer of insulating material, the nanotubes being at least partially covered by at least one metallic material, method comprising, between growing the nanotubes and depositing said metallic material, aligning the nanotubes substantially perpendicularly to the metallic levels by means of an electromagnetic alignment field, followed by depositing of a sheathing material at least partially covering the nanotubes and performing at least individual sheathing of the nanotubes, the electromagnetic alignment field of the nanotubes being maintained during depositing of the sheathing material.

2. The method according to claim 1, wherein the sheathing material plates each nanotube at least partially from the top end thereof.

3. The method according to claim 1, wherein the sheathing material provides a rigid, fixed connection between adjacent nanotubes.

4. The method according to claim 1, wherein the sheathing material is a conducting material.

5. The method according to claim 4, wherein the sheathing material is made from carbon or from a metal chosen from Al, Au, Pd, Ag, Ru, Ni, Fe, Cr, Ti, Cu, Pt, W, Co, or Mo.

6. The method according to claim 5, wherein an alloy between the nanotube and the sheathing material is formed by annealing.

7. The method according to claim 1, wherein the sheathing material is an insulating material chosen from Al₂O₃, MgO, SiO₂, SixNx, SiOC, or TiO₂.
